(19) United States
(12) Patent Application Publication
(10) Pub. No.: US 2008/0229324 A1
(43) Pub. Date: Sep. 18, 2008

(54) SYSTEM AND METHOD FOR SHARING E-SERVICE RESOURCE OF DIGITAL HOME

(75) Inventors: Yung-Shun Huang, Tainan City (TW); Yu-Shiang Sheng, Taipei City (TW); Chia-Shou Tu, Tainan City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: INDUSTRIAL TECHNOLOGY RESEARCH INSTITUTE, Hsinchu (TW)

(21) Appl. No.: 11/736,012

(22) Filed: Apr. 17, 2007

(30) Foreign Application Priority Data
Mar. 16, 2007 (TW) 96109057

(51) Int. Cl. G06F 9/44

(52) U.S. Cl. 719/311

(57) ABSTRACT

A system and a method for sharing the e-service resources of a digital home are provided. Two different Java e-service platforms are built in the same Java Virtual Machine. One Java e-service platform supplies a broadband service channel, for example the Open Service Gateway platform, and another Java e-service platform supplies a broadcast service channel, for example the Multimedia Home Platform. Furthermore, in a parent class loader having the inheritance between the two Java e-service platforms, a bridge class module is established. The two Java e-service platforms set their resource references to the bridge class module for sharing the resources.

### CROSS-REFERENCE TO RELATED APPLICATION

This application claims the priority benefit of Taiwan application serial no. 96109057, filed Mar. 16, 2007. All disclosure of the Taiwan application is incorporated herein by reference.

### BACKGROUND OF THE INVENTION

1. Field of the Invention

The present invention relates to a system for sharing the e-service resources of a digital home and a method thereof.

2. Description of Related Art

With a growing need of digital home and rapid development of Internet, various kinds of communication protocols of home network and middleware platforms appear accordingly, and the integration of the heterogeneous network becomes a great challenge in developing digital home technology. The home gateway and the digital set-top box used for connecting the inside home network with the outside ASP (application service provider) are keys in developing digital home technology.

Since the home gateway is suitable for integrating with the broadband network to provide broadband service and to control the devices within home network; and the digital set-top box having a human computer interface is suitable for providing home multi-media services. Thus, a full service gateway that may provide both broadcast service and broadband service becomes the focus in developing of the field.

In the aspect of the home gateway, the Open Service Gateway platform (Hereinafter referred to as OSGi platform) provided by the OSGi (open services gateway initiative) association is an open standard, the basic structure of the OSGi platform is a Java container. A component model on the OSGi platform is referred to as “Bundle”. The OSGi platform has a Service Registry mechanism. Resources may be shared among the bundles through the OSGi Service Registry.

In the aspect of the digital set-top box, the Multimedia Home Platform (Hereinafter referred to as MHP platform) provided by the European DVB (Digital Video Broadcasting) organization is a standard of the common middleware, the basic structure of the MHP platform is also a Java container. A component model on the MHP platform is referred to as “Xlet”. Similar to the OSGi platform, the MHP platform also has an IxcRegistry mechanism. Resources may also be shared among the Xlets of the MHP platform through the IxcRegistry.

As described above, if services of the OSGi platform and the MHP platform are integrated, full service may be provided. FIG. 1 is a tree structure diagram of the conventional resource sharing system between an OSGi platform and a MHP platform. Referring to FIG. 1, arrows in solid lines represent the inheritance between the nodes. This structure integrated the OSGi platform and the MHP platform into a unified equipment performed in a same Java Virtual Machine. When the Java Virtual Machine performs, the Bootstrap loader 101 and the System class loader 103 are loaded so as to load a common class provided by the Java Virtual Machine. Then, the Application class loader 105 is generated.

When the OSGi application bundle 109 of the OSGi middleware 107 is about to use a resource of the MHP middleware 113, a command message is transmitted to the TCP/IP (Transmission Control Protocol/Internet Protocol) class (shown in dash line arrow A) loaded by the System class loader 103, such that a TCP/IP communication protocol may be used during transmission. And then, the System class loader 103 transmit the command message to the OSGi proxy Xlet 115 of the MHP middleware 113 by using the TCP/IP communication protocol for the MHP middleware 113 performing the command message (shown in dash line arrow B). After the OSGi proxy Xlet 115 has performed the command message by using the MHP middleware 113, a message of performing result is transmitted to the System class loader 103 through the OSGi proxy Xlet 115 by using the TCP/IP communication protocol (shown in dash line arrow C). Finally, the System class loader 103 transmits the response message of performing result to the OSGi application bundle 109 by using the same TCP/IP communication protocol (as shown in dash line arrow D). Similarly, when the MHP application Xlet 117 is about to use a resource of the OSGi middleware 107, the processing steps are similar to above described steps, and the repeated description will be omitted hereby.

In summary, though the OSGi platform and the MHP platform are performed in a same Java Virtual Machine, the TCP/IP protocol has to be applied for sharing resources. Thus, to share resources directly between the home gateway and the digital set-top box is a useful technique in developing digital home technology.

### SUMMARY OF THE INVENTION

The present invention is directed to a system for sharing the e-service resource of a digital home, wherein two different Java e-service platforms are built in the same Java Virtual Machine for sharing the resources.

The present invention is directed to a method for sharing the e-service resource of a digital home, wherein two different Java e-service platforms may directly or indirectly use the Java e-service resources of each other.

The present invention provides a system for sharing the e-service resource of a digital home. The system includes a Java Virtual Machine, a first Java e-service platform, a second Java e-service platform and a bridge class module. The first Java e-service platform and the second Java e-service platform are built in the same Java Virtual Machine. The first Java e-service platform supplies a broadband service channel and first Java e-service resources. The second Java e-service platform supplies a broadcast service channel and second Java e-service resources. Furthermore, a bridge class module is established on the class path of a parent class loader having the inheritance between the two Java e-service platforms. And the two Java e-service platforms respectively set their resource references to the bridge class module for sharing the resources between the two Java e-service platforms.

According to an exemplary embodiment of the present invention, the system includes a Java Virtual Machine, an Open Service Gateway platform, a Java e-service platform and a bridge class module. The Open Service Gateway platform and the Java e-service platform are built in the same Java Virtual Machine. The Open Service Gateway platform supplies a broadband service channel and Open Service Gateway resources. The Java e-service platform supplies Java e-service resources. Furthermore, a bridge class module is established on the class path of a parent class loader having the inheritance between the Open Service Gateway platform and the Java e-service platform. And the Open Service Gateway platform and the Java e-service platform respectively set their resource references to the bridge class module for sharing the resources between the Open Service Gateway platform and the Java e-service platform.

According to an exemplary embodiment of the present invention, the system includes a Java Virtual Machine, a Multimedia Home Platform, a Java e-service platform and a bridge class module. The Multimedia Home Platform and the Java e-service platform are built in the same Java Virtual Machine. The Multimedia Home Platform supplies a broadcast service channel and Multimedia Home Platform resources. The Java e-service platform supplies Java e-service resources. Furthermore, a bridge class module is established on the class path of a parent class loader having the inheritance between the Multimedia Home Platform and the Java e-service platform. And the Multimedia Home Platform and the Java e-service platform respectively set their resource references to the bridge class module for sharing the resources between the Multimedia Home Platform and the Java e-service platform.

The present invention provides a method for sharing the e-service resource of a digital home, and the method is suitable for the first Java e-service platform using the Java e-service resources of the second Java e-service platform, wherein the first Java e-service platform and the second Java e-service platform are built in the same Java Virtual Machine. A bridge class module is established on the class path of a parent class loader having the inheritance between the first Java e-service platform and the second Java e-service platform. The first Java e-service platform may use the Java e-service resources through the bridge class module.

According to an exemplary embodiment of the present invention, the method is suitable for the Java e-service platform using the Open Service Gateway resources of the Open Service Gateway platform, wherein the Open Service Gateway platform and the Java e-service platform are built in the same virtual machine. A bridge class module is established on the class path of a parent class loader having the inheritance between the Open Service Gateway platform and the Java e-service platform. The Java e-service platform may use the Open Service Gateway resources through the bridge class module.

According to an exemplary embodiment of the present invention, the method is suitable for the Java e-service platform using the Multimedia Home Platform resources of the Multimedia Home Platform, wherein the Multimedia Home Platform and the Java e-service platform are built in the same Java virtual machine. A bridge class module is established on the class path of a parent class loader having the inheritance between the Multimedia Home Platform and the Java e-service platform. The Java e-service platform may use the Multimedia Home Platform resources through the bridge class module.

According to an exemplary embodiment of the present invention, since two different Java e-service platforms are built in the same Java Virtual Machine and the bridge class module is established in a parent class loader having the inheritance between the two Java e-service platforms, the two Java e-service platforms may share their resources through the bridge class module.

In order to make the aforementioned features and advantages of the present invention comprehensible, embodiments accompanied with figures is described in detail below.

### BRIEF DESCRIPTION OF THE DRAWINGS

FIG. 1 is a tree structure diagram of the conventional resource sharing system between an OSGi platform and a MHP platform.

FIG. 2 is a system architecture for sharing the e-service resources of a digital home according to a first exemplary embodiment of the present invention.

FIG. 3 is a tree structure diagram of the system for sharing the e-service resources of a digital home according to the first exemplary embodiment of the present invention.

FIG. 4 is a tree structure diagram of the system for sharing the e-service resources of a digital home according to a second exemplary embodiment of the present invention.

FIGS. 5A˜5D are flowcharts illustrating sharing of the e-service resources of a digital home according to the second exemplary embodiment of the present invention.

FIG. 6 is a flowchart illustrating a method for sharing the e-service resources of a digital home according to a third exemplary embodiment of the present invention.

FIG. 7 is a flowchart illustrating another method for sharing the e-service resources of a digital home according to the third exemplary embodiment of the present invention.

FIG. 8A and FIG. 8B are flowcharts illustrating yet another method for sharing the e-service resources of a digital home according to the third exemplary embodiment of the present invention.

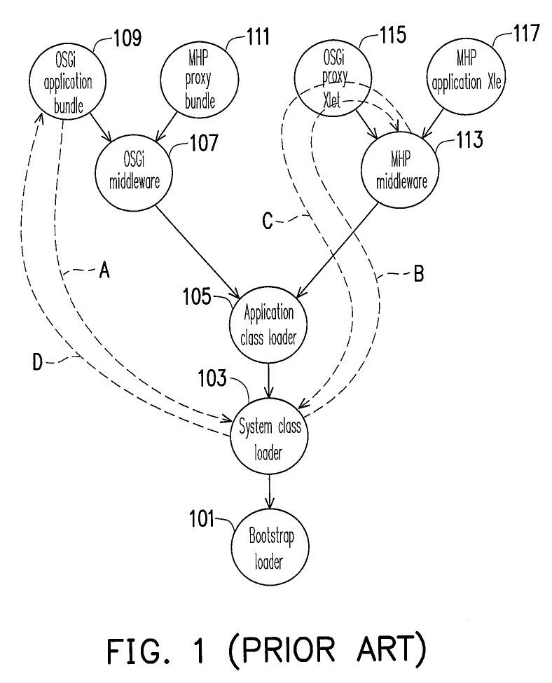

### DESCRIPTION OF EMBODIMENTS

In order to make the content of the present invention comprehensible, exemplary embodiments are described below.

### The First Exemplary Embodiment

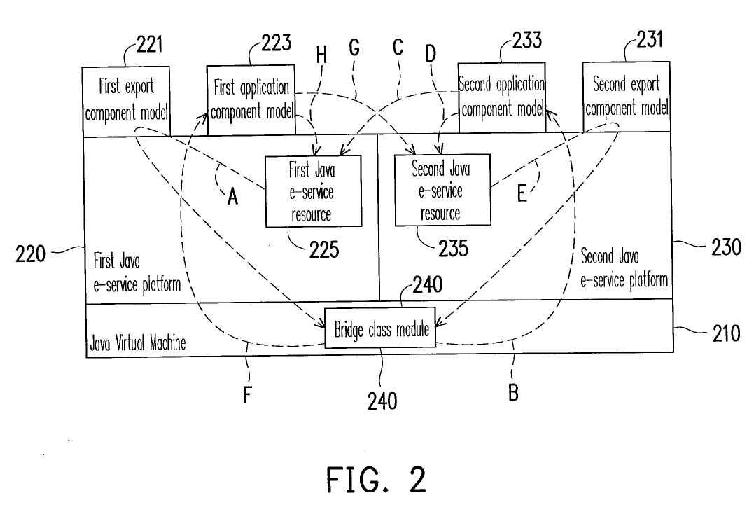

FIG. 2 is a system architecture for sharing the e-service resources of a digital home according to the first exemplary embodiment of the present invention. Referring to FIG. 2, the system includes a Java Virtual Machine 210, a First Java e-service platform 220, a Second Java e-service platform 230 and a Bridge class module 240. The First Java e-service platform 220 and the Second Java e-service platform 230 are built in the Java Virtual Machine 210, and the two platforms share their resources through the Bridge class module 240.

The First Java e-service platform 220 supplies a broadband service channel, and further supplies a First export component model 221, a First application component model 223 and a First Java e-service resources 225 (for example, class or object can be used). The Second Java e-service platform 230 supplies a broadcast service channel, and further supplies a Second export component model 231, a Second application component model 233 and Second Java e-service resources 235.

Moreover, the First Java e-service platform 220 and the Second Java e-service platform 230 are Java middleware, and the Java middleware is a kind of Java container. And thus, dynamic transmission and receiving may be performed on the Java middleware.

The Bridge class module 240 is used for sharing resources between the First Java e-service platform 220 and the Second Java e-service platform 230, and the Bridge class module 240 is established on the class path of a parent class loader having the inheritance between the First Java e-service platform 220 and the Second Java e-service platform 230 such that the Bridge class module 240 may be shared by the First Java e-service platform 220 and the Second Java e-service platform 230.

Wherein the First Java e-service platform 220 and the Second Java e-service platform 230 respectively set the resource reference of the First Java e-service resources 225 and the resource reference of the Second Java e-service resources 235 to the Bridge class module 240.

In other words, the class that can be used by the component models (i.e. 221, 223, 231 and 233) of the First Java e-service platform 220 and the Second Java e-service platform 230 includes the class which the class path of its own class loader point to, and which the class path of all parent class loader having the inheritance point to. Thus, the Bridge class module 240 is disposed on the class path of a parent class loader having the inheritance between the First Java e-service platform 220 and the Second Java e-service platform 230.

The Bridge class module 240 further includes a first Java e-service locator (not shown) and a second Java e-service locator (not shown). The first Java e-service locator is used for saving the resource reference of the First Java e-service resources 225. The second Java e-service locator is used for saving the resource reference of the Second Java e-service resources 235. In other words, the class path of the Bridge class module 240 points to a Java library (not shown) including a first Java e-service locator (not shown) and a second Java e-service locator (not shown).

If the Second application component model 233 of the Second Java e-service platform 230 is about to use the First Java e-service resources 225 of the First Java e-service platform 220, first, the resource reference of the First Java e-service resources 225 is obtained from the First Java e-service platform 220 by the First export component model 221, and the resource reference of the First Java e-service resources 225 is set to the first Java e-service locator (not shown) of the Bridge class module 240 (shown in dash line arrow A). Next, when the Second application component model 233 is about to use the First Java e-service resources 225, the corresponding First Java e-service resources 225 is used (shown in dash line arrow C) according to the resource reference of the First Java e-service resources 225 provided by the first Java e-service locator (not shown) of the Bridge class module 240 (shown in dash line arrow B). Moreover, if the Second application component model 233 of the Second Java e-service platform 230 is about to use the Second Java e-service resources 235, the Second application component model 233 may directly use the Second Java e-service resources 235 (shown in dash line arrow D).

Similarly, if the First application component model 223 of the First Java e-service platform 220 is about to use the Second Java e-service resources 235 of the Second Java e-service platform 230, the steps (shown in dash line arrows E˜G) is similar to the aforementioned steps (shown in dash line arrows A˜D), thus, the detailed description thereof will not be repeated. And if the First application component model 223 of the First Java e-service platform 220 is about to use the First Java e-service resources 225, the First application component model 223 may directly use the First Java e-service resources 225 (shown in dash line arrow H).

It is noticeable that the First Java e-service platform 220 may be an OSGi platform, and the OSGi platform may share resources with any platform built in the Java Virtual Machine 210. For example, the OSGi platform may share resources with the Second Java e-service platform 230. The Second Java e-service platform 230 may be a MHP platform, and the MHP platform may also share resources with any platform built in the Java Virtual Machine 210. For example, the MHP platform may share resources with the First Java e-service platform 220.

The method of sharing resources between the First Java e-service platform 220 and the Second Java e-service platform 230 by using the Bridge class module 240 is more noticeable. For example, the Bridge class module 240 is used as a transmission and receiving channel of objects. In addition, the Bridge class module 240 may be further used as a service proxy, or a transmission and receiving channel of messages etc. The aforementioned application method will be respectively described in the third exemplary embodiment.

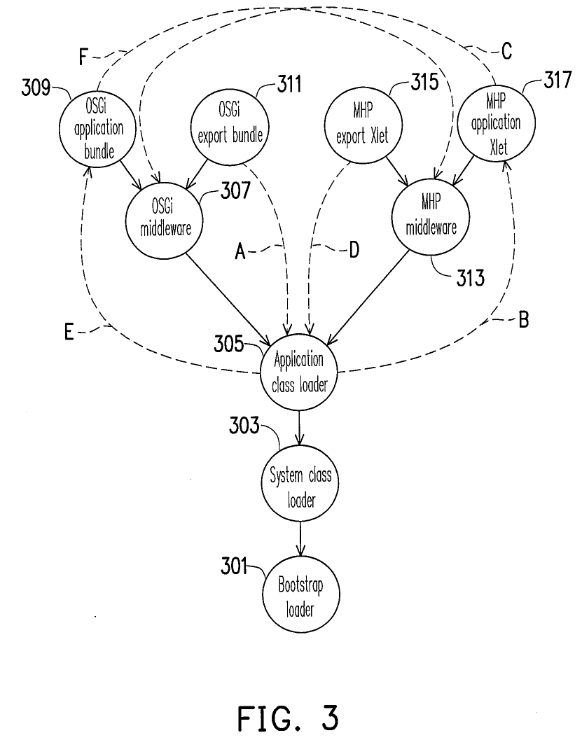

To make the aforementioned concept comprehensive, another exemplary embodiment is provided. FIG. 3 is a tree system architecture for sharing the e-service resources of a digital home according to the first exemplary embodiment of the present invention. Referring to FIG. 2 and FIG. 3, the solid line arrows in FIG. 3 represent the inheritance between the nodes. The First Java e-service platform 220 of the present embodiment may be an OSGi platform, and the Second Java e-service platform 230 may be a MHP platform. The OSGi platform and the MHP platform are Java middleware. The OSGi middleware 307 provides an OSGi application bundle 309 and an OSGi export bundle 311; the MHP middleware 313 provides a MHP export Xlet 315 and a MHP application Xlet 317.

Wherein the OSGi middleware 307 and the MHP middleware 313 are built in the same Java Virtual Machine, and are all disposed on the class path of the Application class loader 305. When the Java Virtual Machine performs, the Bootstrap loader 301 and the System class loader 303 are loaded first for loading the common class provided by the Java Virtual Machine. Next, an Application class loader 305 is generated, and the class path in the Application class loader 305 is searched to determine whether there is a designated class, and the designated class is determined and loaded. In other words, loading of the Java class is performed by the class loaders (such as the Bootstrap loader 301, the System class loader 303 and the Application class loader 305). When a class is about to be used, the class path in the class loader is searched to find whether there is a designated class.

Since the Bridge class module 240 is established in the parent class loader having the inheritance between the OSGi platform and the MHP platform, the Bridge class module 240 may be disposed on the class path of the Bootstrap loader 301, the System class loader 303 or the Application class loader 305 for sharing the resources between the two platforms.

In the present embodiment, the Bridge class module 240 is disposed on the class path of the Application class loader 305. The OSGi middleware 307 or the OSGi export bundle 311 set the resource reference of the open services gateway resources (hereinafter referred to as OSGi resources) to be shared of the OSGi platform to the Bridge class module 240, or otherwise the MHP middleware 313 or the MHP export Xlet 315 set resource reference of the Multimedia Home Platform resources (hereinafter referred to as MHP resources) to be shared of the MHP platform to the Bridge class module 240. Next, the OSGi application bundle 309 and the MHP application Xlet 317 may respectively obtain the resource reference of the OSGi resources and the resource reference of the MHP resources from the Bridge class module 240 to directly use the OSGi resources and the MHP resources.

Referring to FIG. 3 again, when the MHP application Xlet 317 of the MHP platform is about to use the OSGi resources, first, the OSGi export bundle 311 set the resource reference of the OSGi resources to be shared to the Bridge class module 240 which the class path of the Application class loader 305 point to (shown in dash line arrow A). Next, the Application class loader 305 provides the resource reference of the OSGi resources to the MHP application Xlet 317 (shown in dash line arrow B), and then the MHP application Xlet 317 may directly use the OSGi resources from the OSGi middleware 307 (shown in dash line arrow C). Similarly, when the OSGi application bundle 309 of the OSGi platform is about to use the MHP resources, the steps (shown in dash line arrows D˜F) is similar to the aforementioned steps (shown in dash line arrows A˜C), and thus, the detailed description thereof will not be repeated.

To make the aforementioned concept more comprehensive, the case of sharing resources between the OSGi platform and the MHP platform is applied in every following exemplary embodiment. But it should be understood by those of ordinary skill in the art that various kinds of platforms may be used according to the present invention.

### The Second Exemplary Embodiment

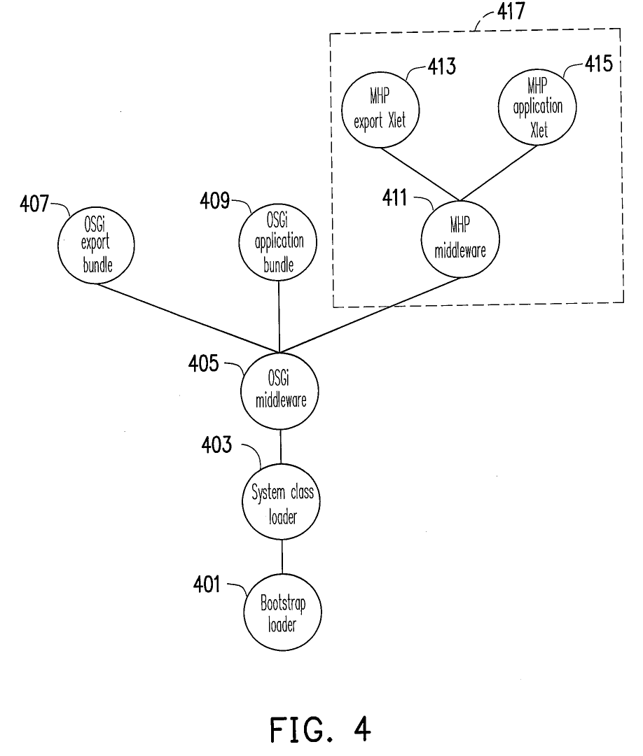

FIG. 4 is a tree structure of the system for sharing the e-service resources of a digital home according to the second exemplary embodiment of the present invention. Referring to FIG. 4, the OSGi middleware 405 provides an OSGi export bundle 407, an OSGi application bundle 409 and a MHP bundle 417, wherein the MHP bundle 417 is a MHP platform packaged as a bundle on the OSGi platform such that the OSGi platform may activate the MHP platform through the MHP bundle 417. The MHP middleware 411 provides a MHP export Xlet 413 and a MHP application Xlet 415.

When the Java Virtual Machine performs, the Bootstrap loader 401 and the System class loader 403 are loaded. In the present embodiment, the Bridge class module (not shown) for connecting the OSGi platform and the MHP platform is disposed in the class path of the System class loader 403. When the System class loader 403 is loaded, the OSGi middleware 405, the OSGi export bundle 407, the OSGi application bundle 409 and the MHP bundle 417 are loaded accordingly.

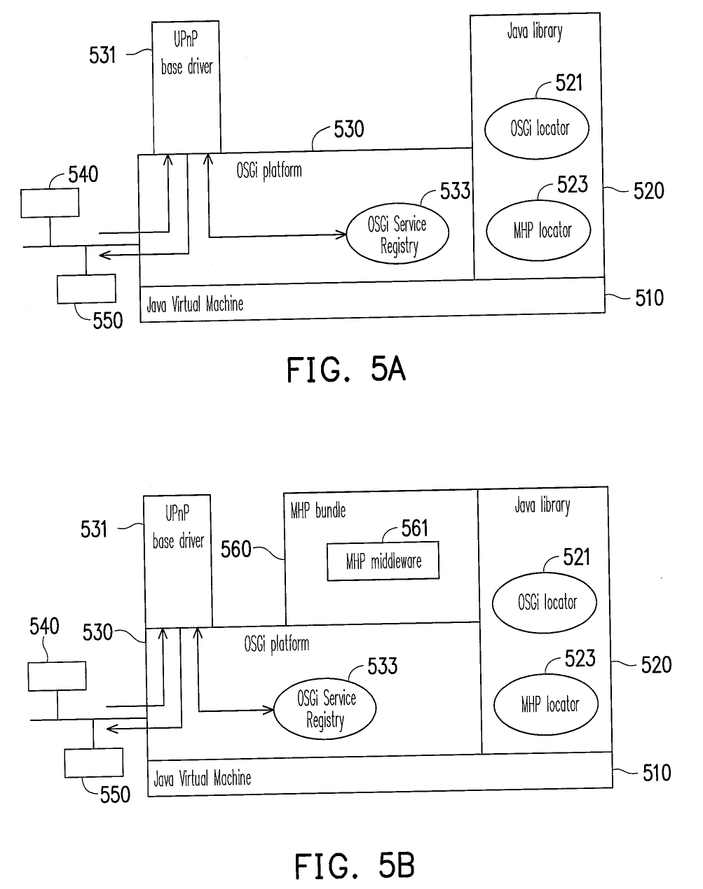

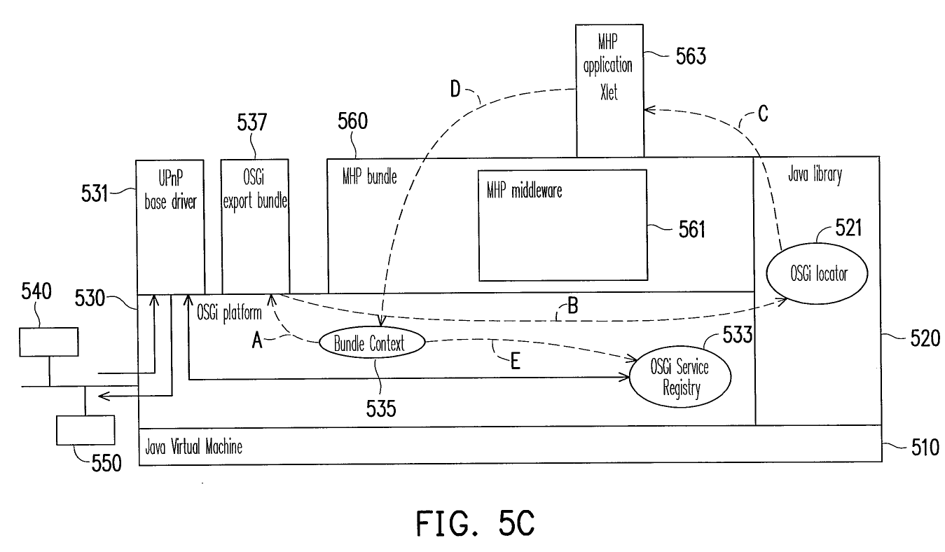

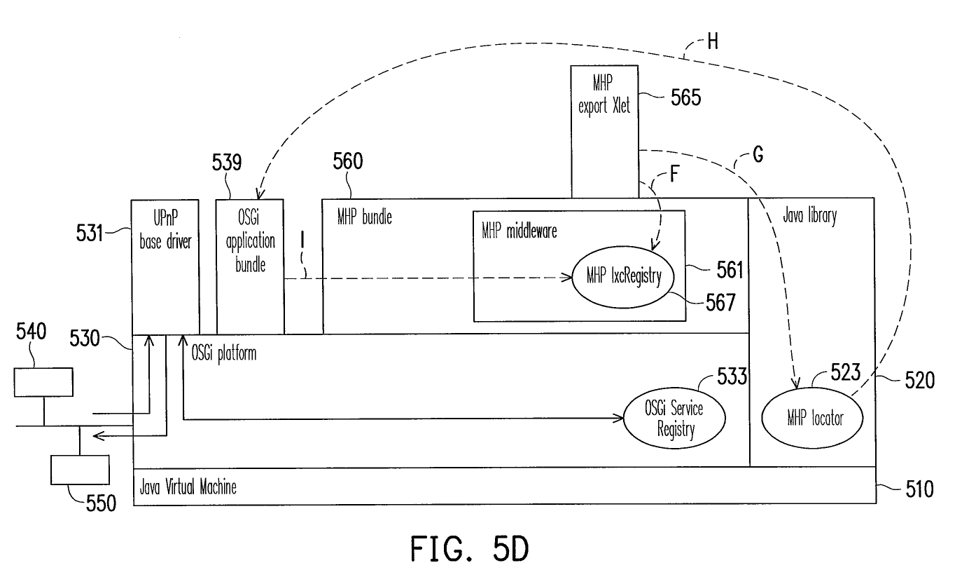

The method of sharing the e-service resources of a digital home will be described in detail below with reference of the tree structure of the system for sharing the e-service resources of a digital home in the aforementioned exemplary embodiment. FIGS. 5A˜5D are flowcharts illustrating the sharing of the e-service resources of a digital home according to the second exemplary embodiment. First, referring to FIG. 4 and FIG. 5A, the system is built in the Java Virtual Machine 510, and a Bridge class module (not shown) is disposed in the class path of the System class loader 403, and the class path of the Bridge class module points to a Java library 520 including an OSGi locator 521 and a MHP locator 523.

Referring to FIG. 5A again, when the Java Virtual Machine 510 performs, the Java library 520 is loaded according to the class path of the Bridge class module, and the OSGi platform 530 is activated to activate the UPNP base driver 531. Meanwhile, the UPNP digital home appliances 540 and 550 are automatically detected, and the service objects of the UPNP digital home appliances 540 and 550 are established and registered in the OSGi Service Registry (hereinafter referred to as OSGi registry) 533 by using the UPnP base driver 531. The UPnP digital home appliances 540 and 550 may be a digital refrigerator and a digital air conditioner etc.

Referring to FIG. 5B, after the OSGi platform 530 is activated, the MHP bundle 560 is activated accordingly, wherein the MHP bundle 560 is a MHP platform packaged as a bundle on the OSGi platform. The MHP bundle 560 includes a MHP middleware 561 for performing the MHP bundle 560 on the OSGi platform 530.

Next, referring to FIG. 5C, when the OSGi platform 530 and the MHP middleware 561 are activated, the OSGi platform 530 activates the OSGi export bundle 537. And when the OSGi export bundle 537 is activated, the OSGi platform 530 supplies an object reference of the bundle context 535 to the OSGi export bundle 537. Thus, the OSGi export bundle 537 may find all the resources available in the OSGi registry 533 of the OSGi platform 530 through the bundle context 535.

Referring to FIG. 5C again, when the MHP middleware 561 is about to control the UPnP digital home appliances 540 and 550 through a home network, first, the OSGi export bundle 537 obtains the object reference of the bundle context 535 from the OSGi platform 530 (shown in dash line arrow A), and sets the object reference of the bundle context 535 to the OSGi locator 521 (shown in dash line arrow B). Second, the MHP application Xlet 563 obtains the object reference of the bundle context 535 from the OSGi locator 521 (shown in dash line arrow C), then, the MHP application Xlet 563 uses the bundle context 535 according to the object reference obtained (shown in dash line arrow D). Finally, the MHP application Xlet 563 obtains the objects of the UPNP digital home appliances 540 and 550 from the OSGi registry 533 through the bundle context 535 (shown in dash line arrow E), so as to control the UPnP digital home appliances 540 and 550 by using the objects of the UPNP digital home appliances 540 and 550.

According to another aspect of the present embodiment, the message of the UPNP digital home appliances 540 and 550 connected to the OSGi platform 530 may be shown on the MHP middleware 561. Referring to FIG. 5D, when the MHP middleware 561 is activated, the MHP export Xlet 565 will be directly activated, and a service, for example, an alarm notify service generated by the MHP export Xlet 565 is set to the MHP IxcRegistry 567 (shown in dash line arrow F).

Next, the MHP export Xlet 565 generates a MHP IxcRegistry proxy (not shown) suitable for using the MHP IxcRegistry 567, and the object reference of the MHP IxcRegistry proxy is set to the MHP locator 523 (shown in dash line arrow G).

Next, the OSGi application bundle 539 may obtain the object reference of the MHP IxcRegistry proxy from the MHP locator 523 (shown in dash line arrow H). Finally, the OSGi application bundle 539 may use the corresponding MHP resources from the MHP IxcRegistry 567 according to the object reference of the MHP IxcRegistry proxy (shown in dash line arrow I).

For example, an alarm notify service program is provided on a digital television (i.e. the MHP middleware 561), wherein the alarm message may be shown on the interface of the digital television by the service program. Thus, messages of the UPNP digital home appliances 540 and 550 connected with the OSGi platform 530 may be shown on the digital television (i.e. the MHP middleware 561), and a user may receive the event notifications of the UPnP digital home appliances 540 and 550 through the interface of the digital television. For example, when the door of a refrigerator is not closed, the alarm message will be shown on the digital television.

In summary, when the OSGi platform 530 and the MHP bundle 560 are activated, the respective object references to be used are set to the Java library 520. The MHP application Xlet 563 and the OSGi application bundle 539 may respectively obtain the resource references of the MHP resources and the OSGi resources from the Java library 520 for using the corresponding MHP resources and the OSGi resources.

### The Third Exemplary Embodiment

Methods of using the bridge class module for sharing the resources, such as using the bridge class module as a transmission and receiving channel of objects, or using the bridge class module as a service proxy or as a transmission and receiving channel of messages etc. will be respectively described with examples as follows.

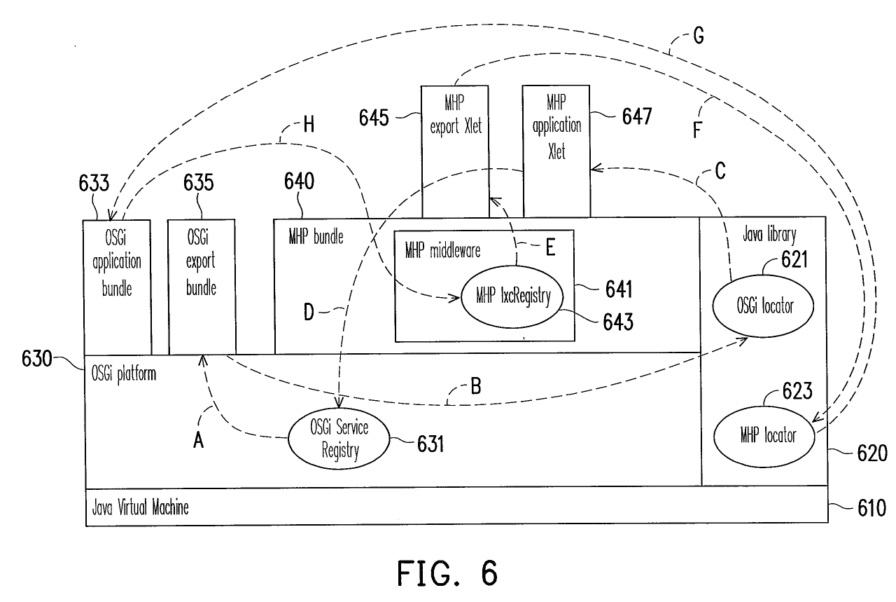

FIG. 6 is a flowchart illustrating a method for sharing the e-service resources of a digital home according to the third exemplary embodiment of the present invention. Referring to FIG. 6, the system architecture of the third exemplary embodiment is similar to that of the second exemplary embodiment, thus, the description of the repeated parts will not be omitted hereby. In the present embodiment, the Bridge class module (not shown) is used as a transmission and receiving channel of the objects. Bundles on the OSGi platform 630 and Xlets on the MHP middleware 641 (i.e. 633, 635, 645 and 647) transmit and receive the object references for using the resources on different platforms. The process of resources sharing is described as follows.

The OSGi export bundle 635 obtains an object reference from the OSGi registry 631 (shown in dash line arrow A), and directly transmits the object reference to the OSGi locator 621 (shown in dash line arrow B). Next, the MHP application Xlet 647 may directly use the OSGi registry 631 (shown in dash line arrow D) according to the object reference provided by the OSGi locator 621 (shown in dash line arrow C).

Similarly, the MHP export Xlet 645 obtains an object reference from the MHP IxcRegistry 643, and directly transmits the object reference to the MHP locator 623. Next, the OSGi application bundle 633 may directly use the MHP IxcRegistry 643 according to the object reference provided by the MHP locator 623 (shown in dash line arrows E˜H).

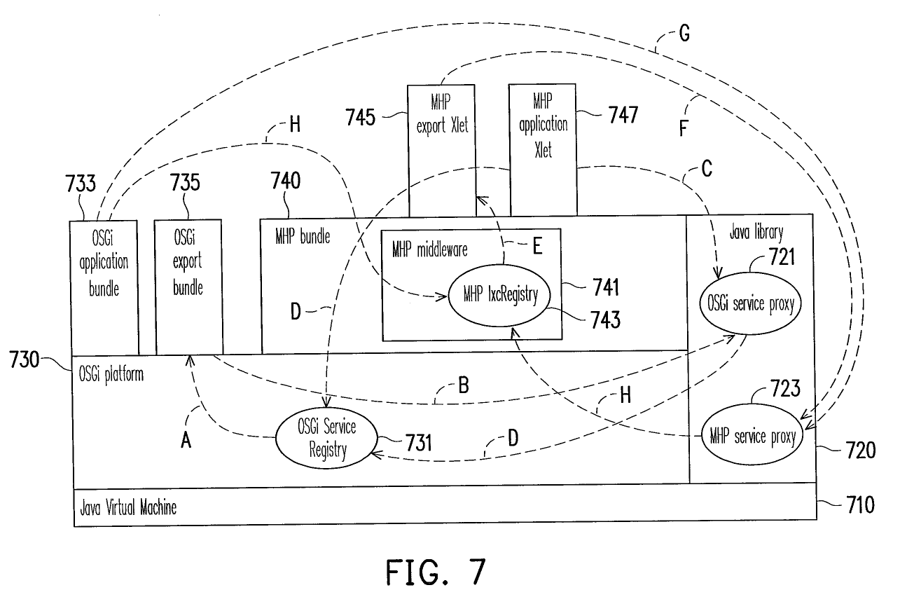

FIG. 7 is a flowchart illustrating another method for sharing the e-service resources of a digital home according to the third exemplary embodiment of the present invention. Referring to FIG. 7, the system architecture of this exemplary embodiment is similar to that of the second exemplary embodiment, thus, the description of the repeated parts will not be repeated. The difference is that the Bridge class module (not shown) is used as a service proxy in the present embodiment. Thus, the Java library 720 that the class path of the Bridge class module (not shown) point to includes an OSGi service proxy 721 and a MHP service proxy 723. The process of resources sharing is described as follows.

The OSGi export bundle 735 obtains an object reference from the OSGi registry 731, and save the object reference in the OSGi service proxy 721. Next, the MHP application Xlet 747 may use the OSGi registry 731 through the OSGi service proxy 721 (shown in dash line arrows A˜D). Similarly, the MHP export Xlet 745 obtains an object reference from the MHP IxcRegistry 743, and save the object reference in the MHP service proxy 723. Next, the OSGi application bundle 733 may use the MHP IxcRegistry 743 through the MHP service proxy 723 (shown in dash line arrows E˜H).

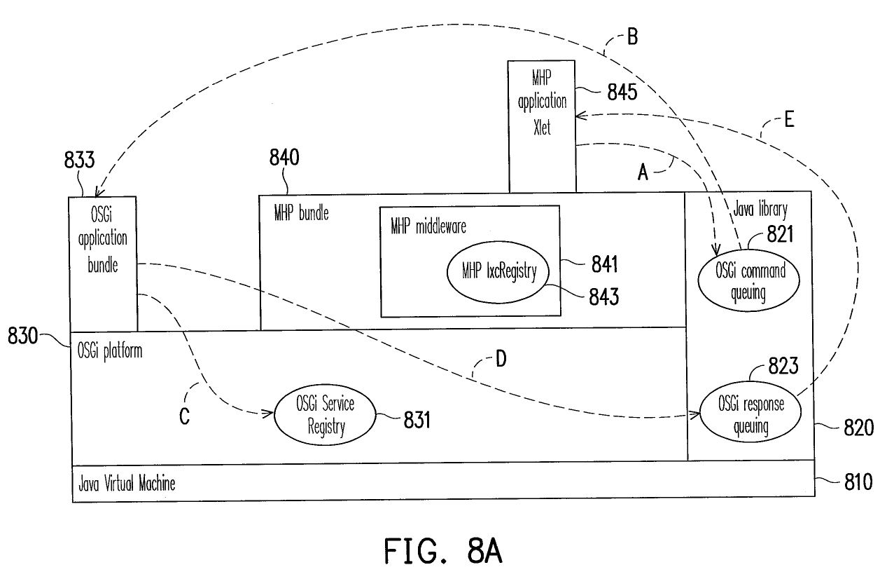

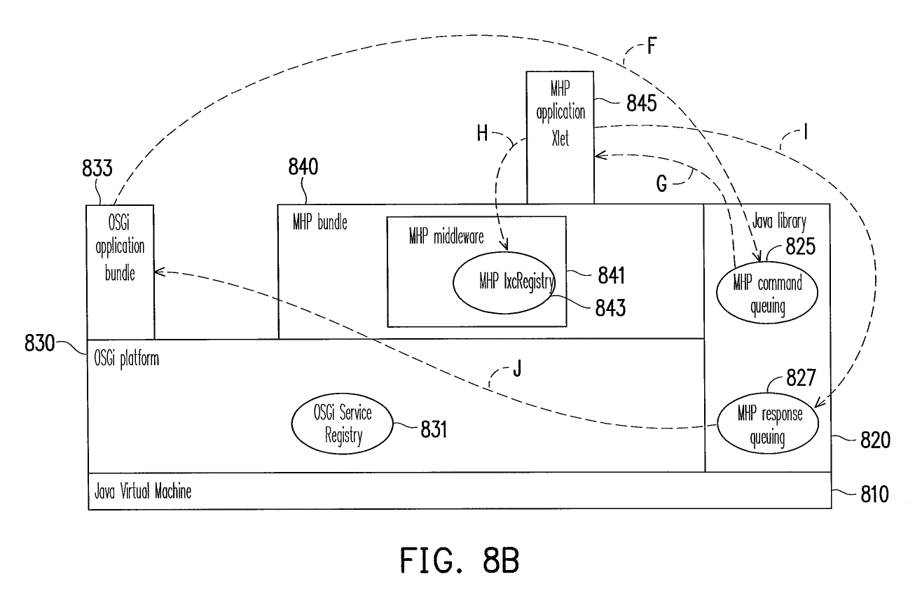

FIG. 8A and FIG. 8B are flowcharts illustrating yet another method for sharing the e-service resources of a digital home according to the third exemplary embodiment of the present invention. Referring to FIG. 8A and FIG. 8B, the system architecture of this embodiment is similar to that of the second exemplary embodiment, thus, the description of the repeated parts will not be repeated. The difference is that the Bridge class module (not shown) is used for transmitting and receiving of the message in the present embodiment. Thus, the Java library 820 that the class path of the Bridge class module (not shown) points to includes an OSGi command queuing 821, an OSGi response queuing 823, a MHP command queuing 825 and a MHP response queuing 827. The process of resources sharing is described as follows.

Referring to FIG. 8A, the MHP application Xlet 845 sets the command message of the OSGi registry 831 to be used to the OSGi command queuing 821 (shown in dash line arrow A). Next, the OSGi application bundle 833 obtains the command message from the OSGi command queuing 821 (shown in dash line arrow B), and uses the OSGi registry 831 according to the command message (shown in dash line arrow C). Next, the OSGi application bundle 833 save the response message (a result of using the OSGi registry 831) to the OSGi response queuing 823 (shown in dash line arrow D). Finally, the MHP application Xlet 845 may obtain the response message from the OSGi response queuing 823 (shown in dash line arrow E).

Similarly, referring to FIG. 8B, the OSGi application bundle 833 sets the command message of the MHP IxcRegistry 843 to be used to the MHP command queuing 825. Next, the MHP application Xlet 845 obtains the command message from the MHP command queuing 825, and uses the MHP IxcRegistry 843 according to the command message. Next, the MHP application Xlet 845 saves the response message (a result of using the MHP IxcRegistry 843) to the MHP response queuing 827. Finally, the OSGi application bundle 833 may obtain the response message from the MHP response queuing 827 (shown in dash line arrows F˜I).

In summary, the system and method of the present invention for sharing the e-service resources of a digital home have at least the following advantages:

1. Two Java e-service platforms are integrated in the same Java Virtual Machine for sharing resources, extra hardware devices is not required, and it is easy to be implemented.

2. Since the Java e-service platform is a kind of Java container itself, dynamic transmission and receiving may be performed on the Java e-service platform. Thus, the system and method of the present invention have the advantages of high performance efficiency and low system resource requirement.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for sharing the e-service resources of a digital home comprising:
a Java Virtual Machine;
an Open Service Gateway platform, built in the Java Virtual Machine, configured to supply a broadband service channel and a plurality of Open Service Gateway resources;
a Java e-service platform, built in the Java Virtual Machine, configured to supply a plurality of Java e-service resources; and
a bridge class module, established on the class path of a parent class loader having the inheritance between the Open Service Gateway platform and the Java e-service platform, the bridge class module being shared by the Open Service Gateway platform and the Java e-service platform, and being used for sharing resources between the Open Service Gateway platform and the Java e-service platform;
wherein the Open Service Gateway platform and the Java e-service platform respectively set a resource reference of the Open Service Gateway resources and a resource reference of the Java e-service resources to the bridge class module.

2. The system for sharing the e-service resources of a digital home as claimed in claim 1, wherein the bridge class module comprises:
an Open Service Gateway locator, configured to save the resource reference of the Open Service Gateway resources; and
a Java e-service locator, configured to save the resource reference of the Java e-service resources.

3. The system for sharing the e-service resources of a digital home as claimed in claim 2, wherein the Open Service Gateway platform comprises:
a first export bundle, configured to obtain the resource reference of the Open Service Gateway resources from the Open Service Gateway platform, and configured to set the resource reference of the Open Service Gateway resources to the Open Service Gateway locator; and
a first application bundle, configured to obtain the resource reference of any of the Java e-service resources from the Java e-service locator for using corresponding Java e-service resources according to the resource reference of any of Java e-service resources obtained.

4. The system for sharing the e-service resources of a digital home as claimed in claim 2, wherein the Java e-service platform comprises:
a second export component model, configured to obtain the resource reference of the Java e-service resources from the Java e-service platform, and configured to set the resource reference of the Java e-service resources to the Java e-service locator; and
a second application component model, configured to obtain the resource reference of any of the Open Service Gateway resources from the Open Service Gateway platform locator for using any of the corresponding Open Service Gateway resources according to the resource reference of any of the Open Service Gateway resources obtained.

5. A system for sharing the e-service resources of a digital home comprising:
a Java Virtual Machine;
a Multimedia Home Platform, built in the Java Virtual Machine, configured to supply a broadcast service channel and a plurality of Multimedia Home Platform resources;
a Java e-service platform, built in the Java Virtual Machine, configured to supply a plurality of Java e-service resources; and
a bridge class module, established on a class path of a parent class loader having an inheritance between the Multimedia Home Platform and the Java e-service platform, the bridge class module being shared by the Multimedia Home Platform and the Java e-service platform, and being used for sharing resources between the Multimedia Home Platform and the Java e-service platform;
wherein the Multimedia Home Platform and the Java e-service platform respectively set a resource reference of the Multimedia Home Platform resources and a resource reference of the Java e-service resources to the bridge class module.

6. The system for sharing the e-service resources of a digital home as claimed in claim 5, wherein the bridge class module comprises:
a Multimedia Home Platform locator, configured to save the resource reference of the Multimedia Home Platform resources; and
a Java e-service locator, configured to save the resource reference of the Java e-service resources.

7. The system for sharing the e-service resources of a digital home as claimed in claim 6, wherein the Multimedia Home Platform comprises:
a first export Xlet, configured to obtain the resource reference of the Multimedia Home Platform resources from the Multimedia Home Platform, and configured to set the resource reference of the Multimedia Home Platform resources to the Multimedia Home Platform locator; and
a first application Xlet, configured to obtain the resource reference of any of the Java e-service resources from the Java e-service locator for using any of corresponding Java e-service resources according to the resource reference of any of the Java e-service resources obtained.

8. The system for sharing the e-service resources of a digital home as claimed in claim 6, wherein the Java e-service platform comprises:
a second export component model, configured to obtain the resource reference of the Java e-service resources from the Java e-service platform, and configured to set the resource reference of the Java e-service resources to the Java e-service locator; and
a second application component model, configured to obtain the resource reference of any of the Multimedia Home Platform resources from the Multimedia Home Platform locator for using any of the corresponding Multimedia Home Platform resources according to the resource reference of any of the Multimedia Home Platform resources obtained.

9. A system for sharing the e-service resources of a digital home comprising:
a Java Virtual Machine;
a first Java e-service platform, built in the Java Virtual Machine, configured to supply a broadband service channel and a plurality of first Java e-service resources;
a second Java e-service platform, built in the Java Virtual Machine, configured to supply a broadcast service channel and a plurality of second Java e-service resources; and
a bridge class module, established on a class path of a parent class loader having an inheritance between the first Java e-service platform and the second Java e-service platform, the bridge class module being shared by the first Java e-service platform and the second Java e-service platform, and being used for sharing resources between the first Java e-service platform and the second Java e-service platform;
wherein the first Java e-service platform and the second Java e-service platform respectively set a resource reference of the first Java e-service resources and a resource reference of the second Java e-service resources to the bridge class module.

10. The system for sharing the e-service resources of a digital home as claimed in claim 9, wherein the bridge class module comprises:
a first Java e-service locator, configured to save the resource reference of the first Java e-service resources; and
a second Java e-service locator, configured to save the resource reference of the second Java e-service resources.

11. The system for sharing the e-service resources of a digital home as claimed in claim 10, wherein the first Java e-service platform comprises:
a first export component model, configured to obtain the resource reference of the first Java e-service resources from the first Java e-service platform, and configured to set the resource reference of the first Java e-service resources to the first Java e-service platform locator; and
a first application component model, configured to obtain the resource reference of any of the second Java e-service resources from the second Java e-service locator for using any of the corresponding second Java e-service resources according to the resource reference of any of the second Java e-service resources obtained.

12. The system for sharing the e-service resources of a digital home as claimed in claim 10, wherein the second Java e-service platform comprises:
a second export component model, configured to obtain the resource reference of the second Java e-service resources from the second Java e-service platform, and configured to set the resource reference of the second Java e-service resources to the second Java e-service locator; and
a second application component model, configured to obtain the resource reference of any of the first Java e-service resources from the first Java e-service locator for using any of the corresponding first Java e-service resources according to the resource reference of any of the first Java e-service resources obtained.

13. The system for sharing the e-service resources of a digital home as claimed in claim 9, wherein the first Java e-service platform comprises an Open Service Gateway platform.

14. The system for sharing the e-service resources of a digital home as claimed in claim 9, wherein the second Java e-service platform comprises a Multimedia Home Platform.

15. A method for sharing the e-service resources of a digital home, applicable to a Java e-service platform using a plurality of Open Service Gateway resources of an Open Service Gateway platform, wherein the Open Service Gateway platform and the Java e-service platform are built in the same Java Virtual Machine, the method for sharing the e-service resources of a digital home comprises:
establishing a bridge class module on a class path of a parent class loader having the inheritance between the Open Service Gateway platform and the Java e-service platform for the bridge class module being shared by the Open Service Gateway platform and the Java e-service platform; and
using any of the Open Service Gateway resources by the Java e-service platform through the bridge class module.

16. The method for sharing the e-service resources of a digital home as claimed in claim 15, wherein the steps of using any of the Open Service Gateway resources comprise:
obtaining the object reference of any of the Open Service Gateway resources by the Java e-service platform through the bridge class module; and
using the corresponding any of the Open Service Gateway resources from the Open Service Gateway platform according to the object reference of any of the Open Service Gateway resources.

17. The method for sharing the e-service resources of a digital home as claimed in claim 15, wherein the steps of using any of the Open Service Gateway resources comprise:
using the bridge class module as a service proxy for setting the object of the Open Service Gateway resources to the service proxy; and
using the object of any of the Open Service Gateway resources through the service proxy.

18. The method for sharing the e-service resources of a digital home as claimed in claim 15, wherein the steps of using any of the Open Service Gateway resources comprise:
setting a command message of the Open Service Gateway platform to be used to the bridge class module by the Java e-service platform;
obtaining the command message from the bridge class module by the Open Service Gateway platform, and using any of the Open Service Gateway resources according to the command message;
transmitting a response message to the bridge class module by the Open Service Gateway platform; and
obtaining the response message from the bridge class module by the Java e-service platform.

19. A method for sharing the e-service resources of a digital home, applicable to a Java e-service platform using a plurality of Multimedia Home Platform resources of a Multimedia Home Platform, wherein the Multimedia Home Platform and the Java e-service platform are built in the same Java Virtual Machine, the method for sharing the e-service resources of a digital home comprises:
establishing a bridge class module on the class path of a parent class loader having the inheritance between the Multimedia Home Platform and the Java e-service platform for the bridge class module being shared by the Multimedia Home Platform and the Java e-service platform; and
using any of the Multimedia Home Platform resources by the Java e-service platform through the bridge class module.

20. The method for sharing the e-service resources of a digital home as claimed in claim 19, wherein the steps of using any of the Multimedia Home Platform resources comprise:
obtaining the object reference of any of the Multimedia Home Platform resources by the Java e-service platform through the bridge class module; and
using corresponding Multimedia Home Platform resources from the Multimedia Home Platform according to the object reference of any of the Multimedia Home Platform resources.

21. The method for sharing the e-service resources of a digital home as claimed in claim 19, wherein the steps of using any of the Multimedia Home Platform resources comprise:
using the bridge class module as a service proxy for setting the object of the Multimedia Home Platform resources to the service proxy; and
using the object of any of the Multimedia Home Platform resources through the service proxy.

22. The method for sharing the e-service resources of a digital home as claimed in claim 19, wherein the steps of using any of the Multimedia Home Platform resources comprise:
setting a command message of the Multimedia Home Platform to be used to the bridge class module by the Java e-service platform;
obtaining the command message from the bridge class module by the Multimedia Home Platform, and using any of the Multimedia Home Platform resources according to the command message;
transmitting a response message to the bridge class module by the Multimedia Home Platform; and
obtaining the response message from the bridge class module by the Java e-service platform.

23. A method for sharing the e-service resources of a digital home, applicable to a first Java e-service platform using a plurality of Java e-service resources of a second Java e-service platform, wherein the first Java e-service platform and the second Java e-service platform are built in the same Java Virtual Machine, the method for sharing the e-service resources of a digital home comprises:
establishing a bridge class module on the class path of a parent class loader having the inheritance between the first Java e-service platform and the second Java e-service platform for the bridge class module being shared by the first Java e-service platform and the second Java e-service platform; and
using any of the Java e-service resources by the first Java e-service platform through the bridge class module.

24. The method for sharing the e-service resources of a digital home as claimed in claim 23, wherein the steps of using any of the Java e-service resources comprise:
obtaining the object reference of any of the Java e-service resources through the bridge class module by the first Java e-service platform; and
using any of the corresponding Java e-service resources from the second Java e-service platform according to the object reference of any of the Java e-service resources.

25. The method for sharing the e-service resources of a digital home as claimed in claim 23, wherein the steps of using any of the Java e-service resources comprise:
using the bridge class module as a service proxy for setting the object of the Java e-service resources to the service proxy; and
using the object of any of the Java e-service resources through the service proxy.

26. The method for sharing the e-service resources of a digital home as claimed in claim 25, wherein the steps of using any of the Java e-service resources comprise:
setting a command message of the second Java e-service platform to be used to the bridge class module by the first Java e-service platform;
obtaining the command message from the bridge class module by the second Java e-service platform, and using any of the Java e-service resources according to the command message;
transmitting a response message to the bridge class module by the second Java e-service platform; and
obtaining the response message from the bridge class module by the first Java e-service platform.

27. The method for sharing the e-service resources of a digital home as claimed in claim 25, wherein the first Java e-service platform supplies a broadband service channel and the second Java e-service platform supplies a broadcast service channel.

28. The method for sharing the e-service resources of a digital home as claimed in claim 25, wherein the first Java e-service platform supplies a broadcast service channel and the second Java e-service platform supplies a broadband service channel.
